(19) United States
(12) Patent Application Publication
(10) Pub. No.: US 2011/0234358 A1
(43) Pub. Date: Sep. 29, 2011

(54) Laminated Inductive Device

(75) Inventors: Shin Katsumata, Rockford, IL (US); Stephen George Mican, West Point, CA (US)

(73) Assignee: Hamilton Sundstrand Corporation, Windsor Locks, CT (US)

(21) Appl. No.: 12/731,898

(22) Filed: Mar. 25, 2010

(51) Int. Cl. H01F 5/00

(52) U.S. Cl. 336/200

(57) ABSTRACT

An inductive electrical device comprises multiple laminations, each lamination comprising: a generally planar electrically nonconductive substrate that has a central axis normal to its plane, a first surface and a second surface; at least one electrically conductive layer pattern along the first surface in the form of a narrow strip that starts from a first point displaced from the central axis and extends along the first surface about the central axis through a first angle of rotation to a second point; a least one electrically conductive layer pattern along the second surface in the form of a narrow strip that starts from the second point and extends along the second surface about the central axis through a second angle of rotation to at least the first point; an electrically conductive coupling region passing through the substrate proximate the second point that couples the electrically conductive layer pattern along the first surface to the electrically conductive layer pattern along the second surface; wherein stacking the laminations upon each other form at least one winding with multiple turns for the inductive device.

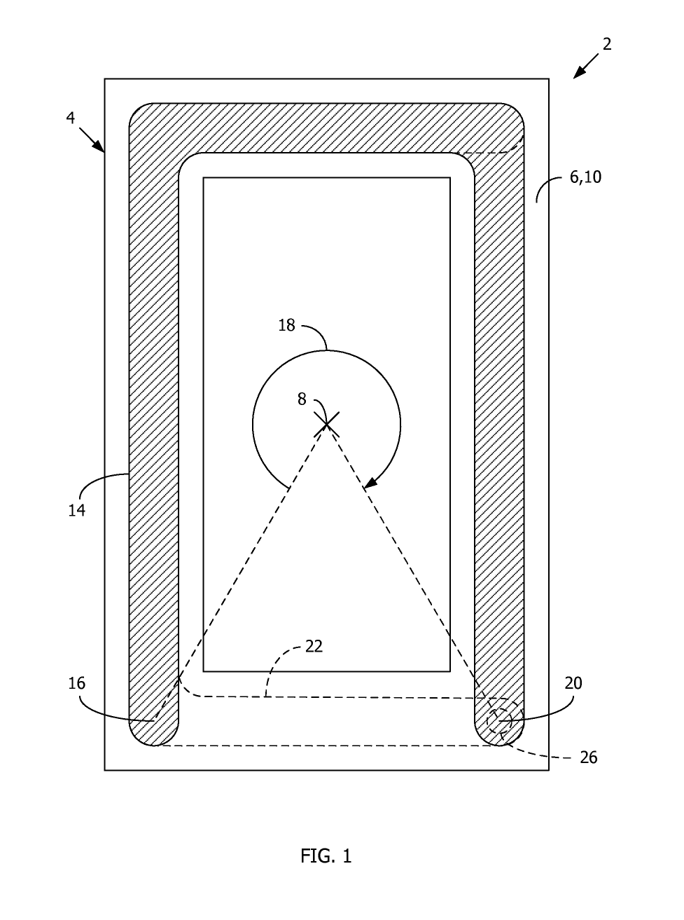

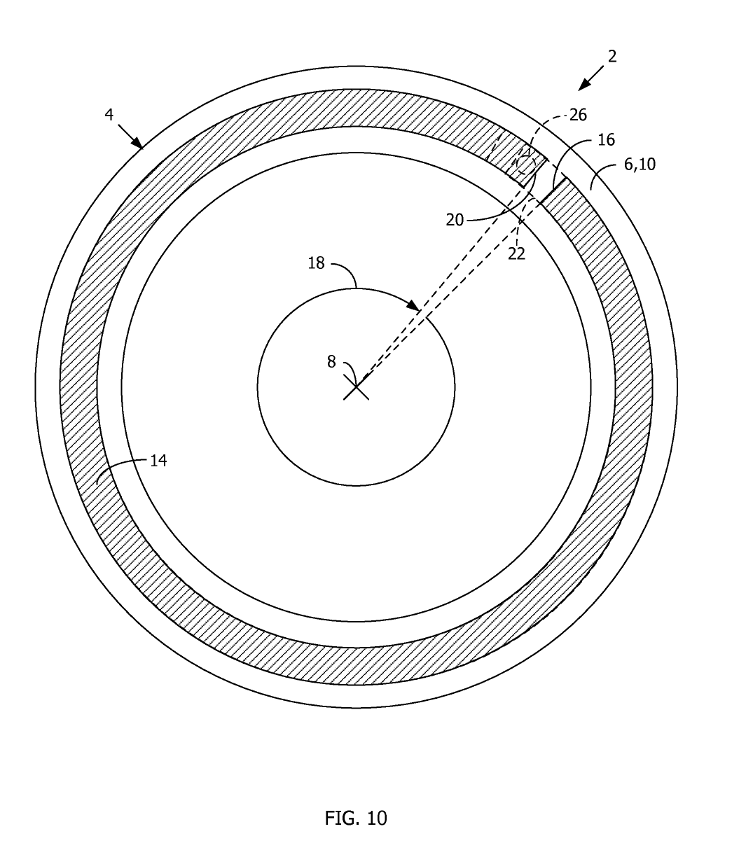

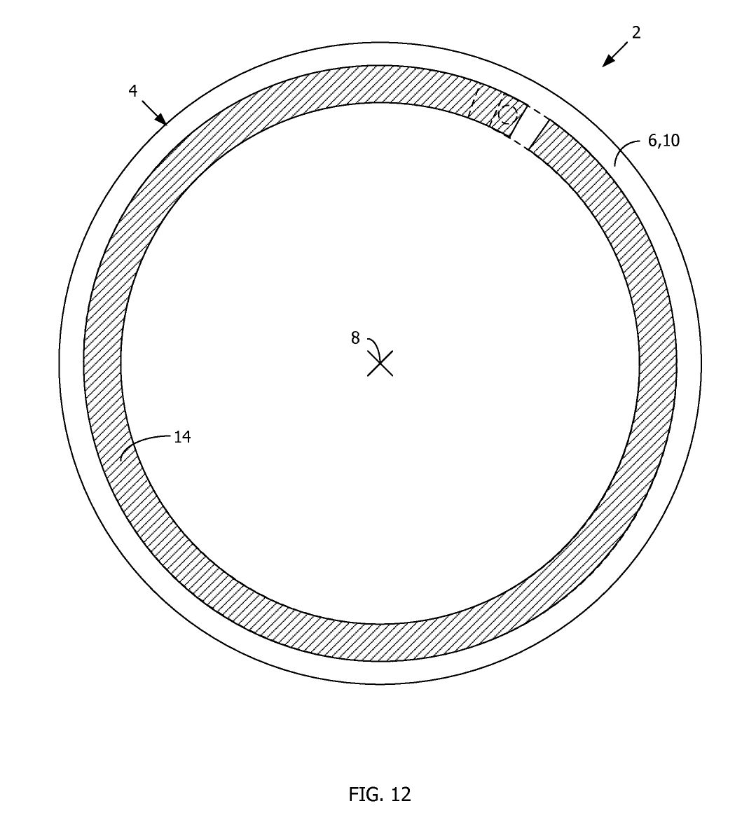

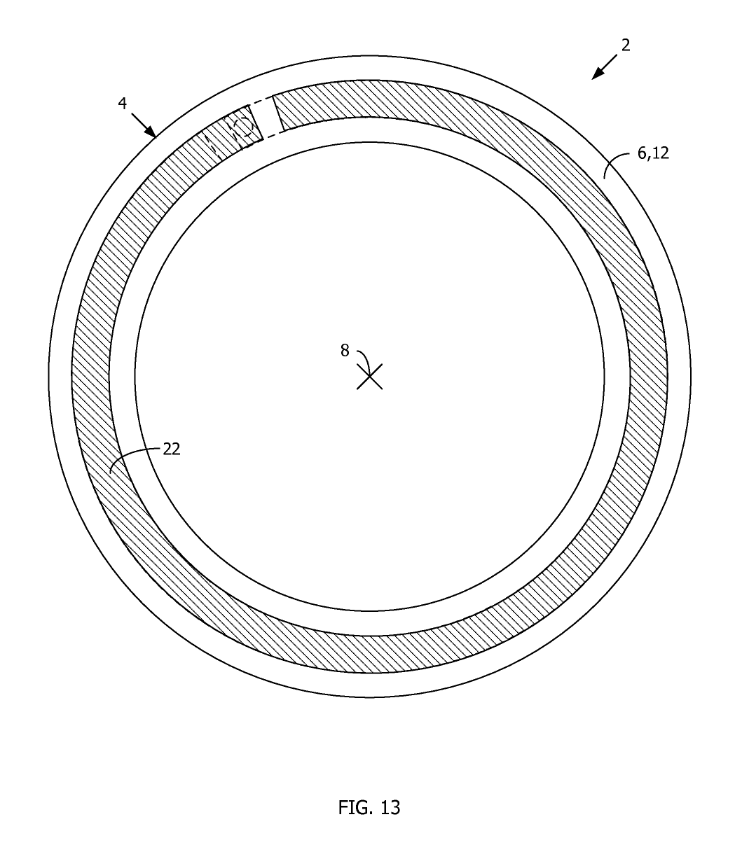

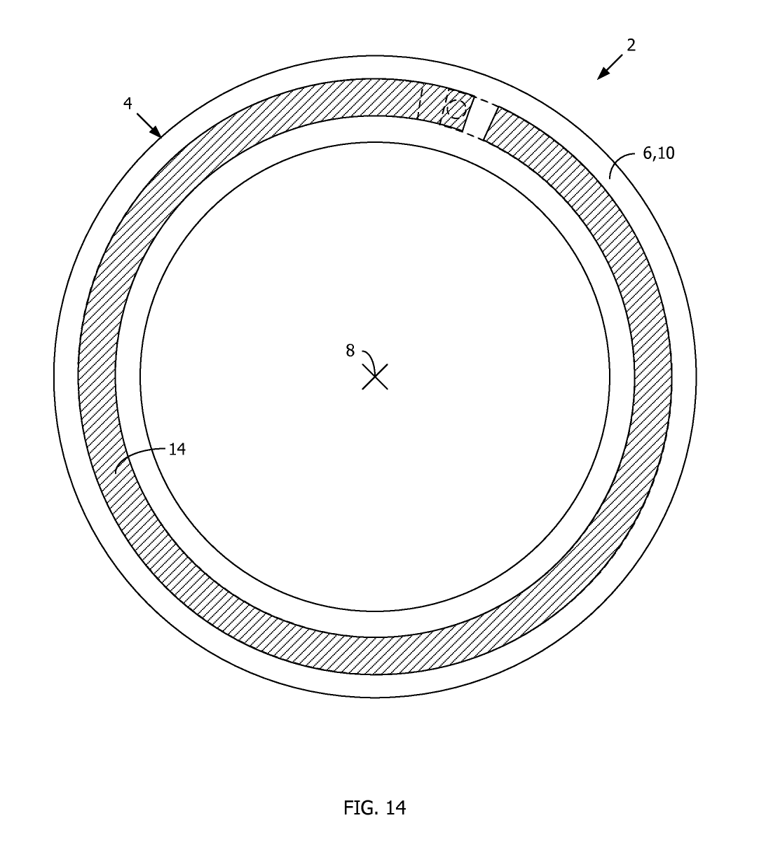

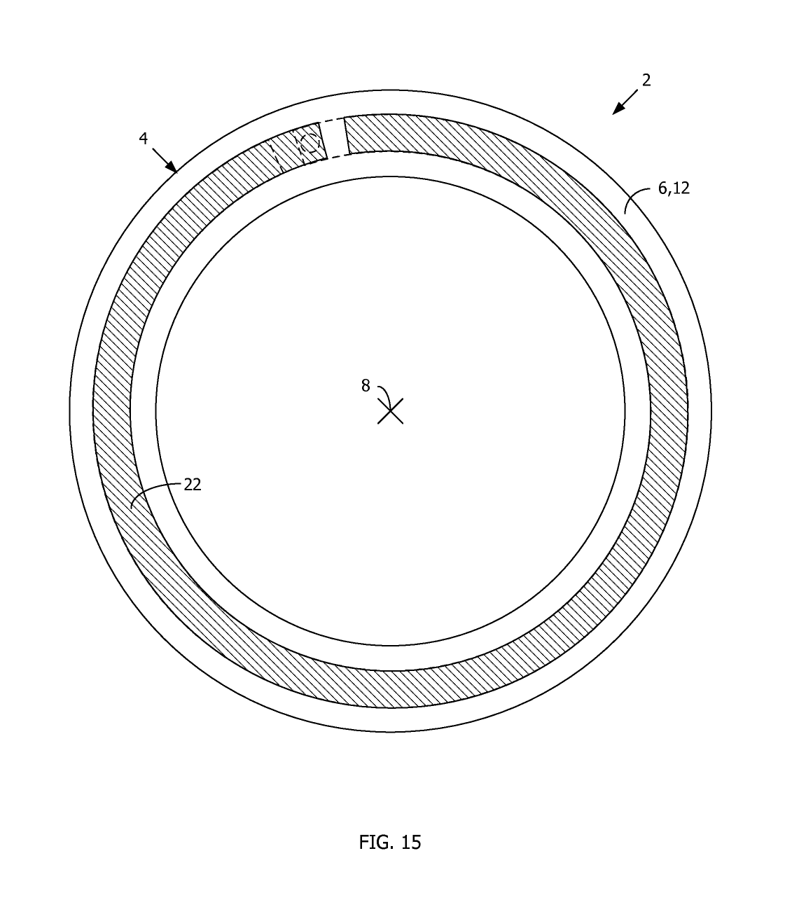

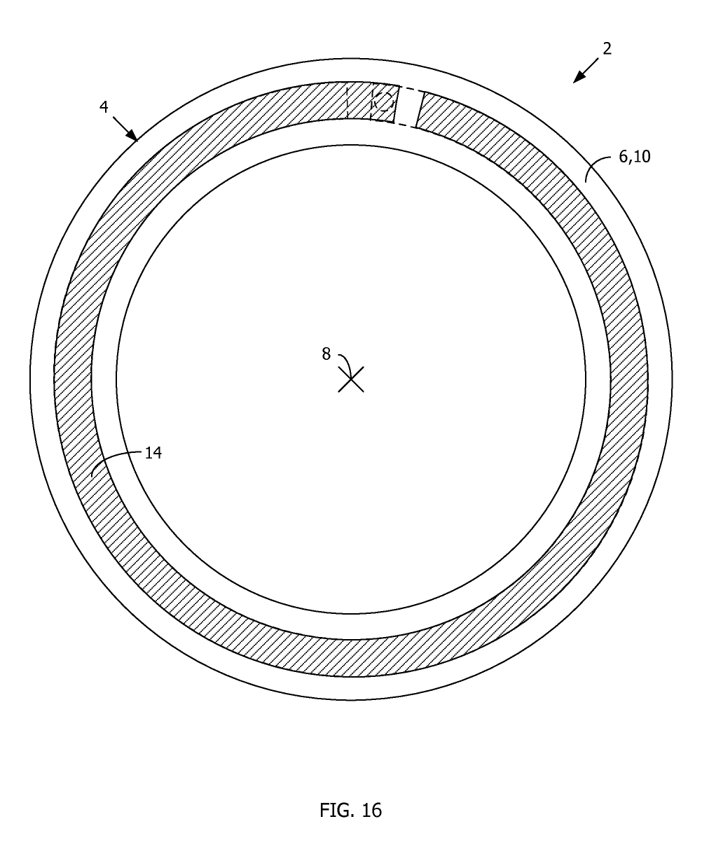

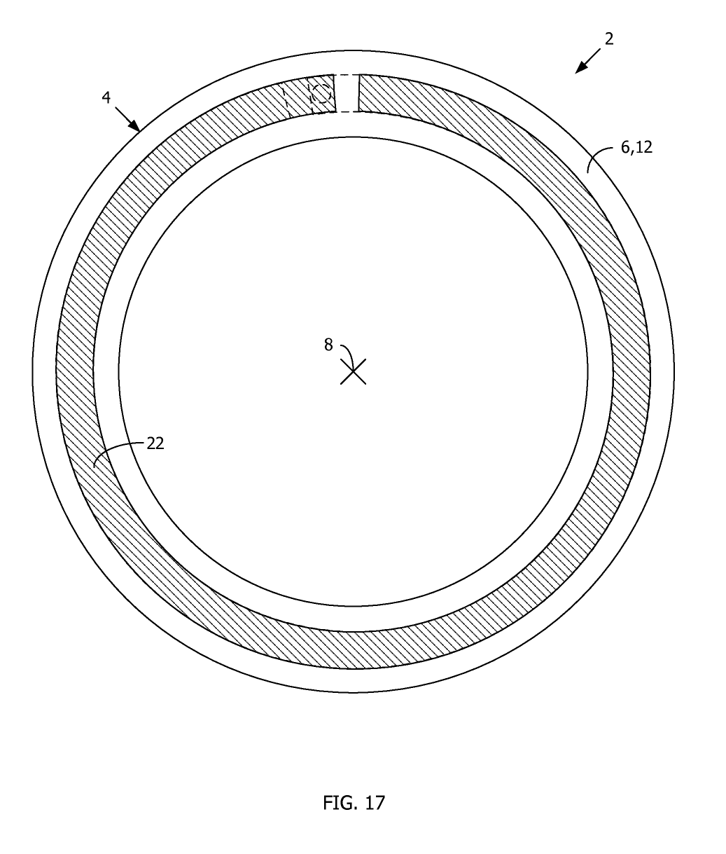

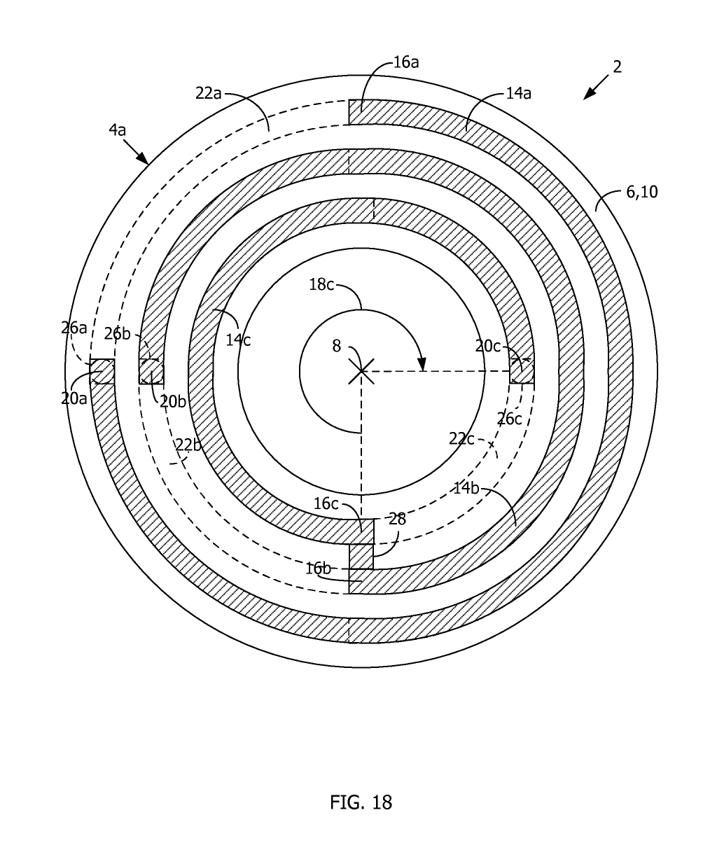

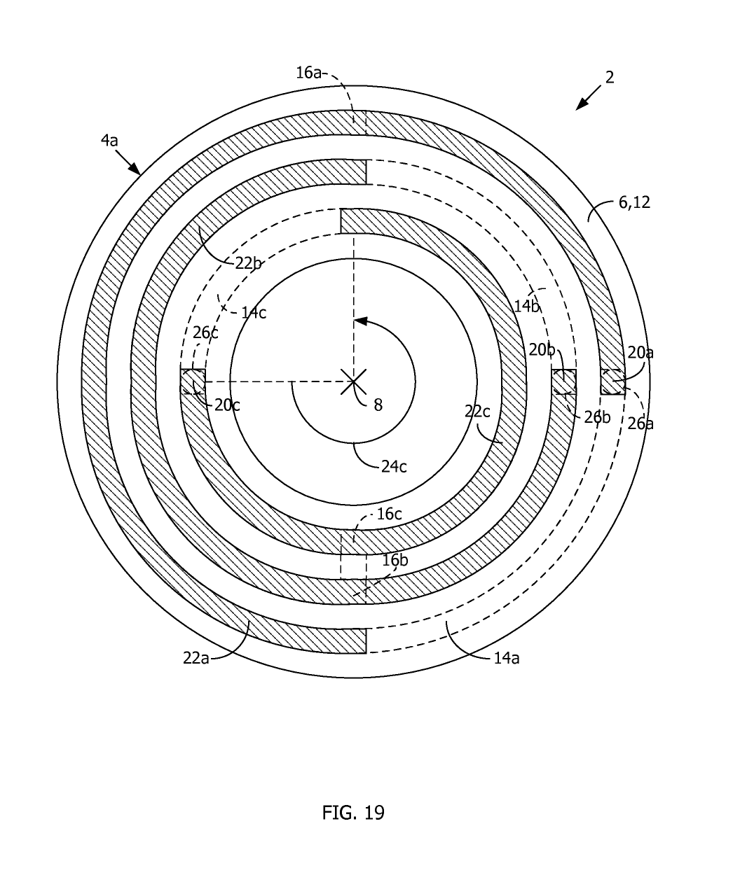

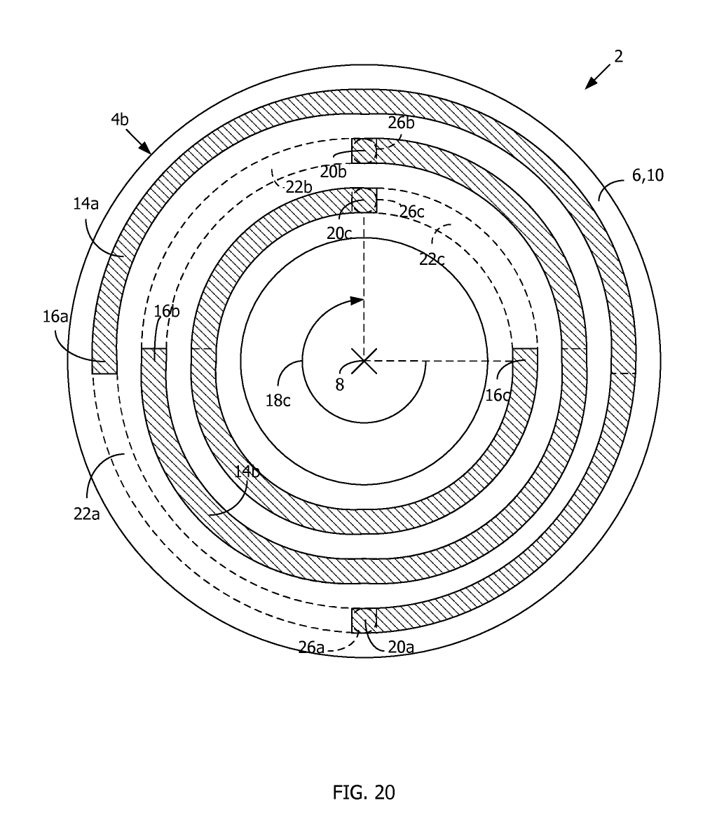

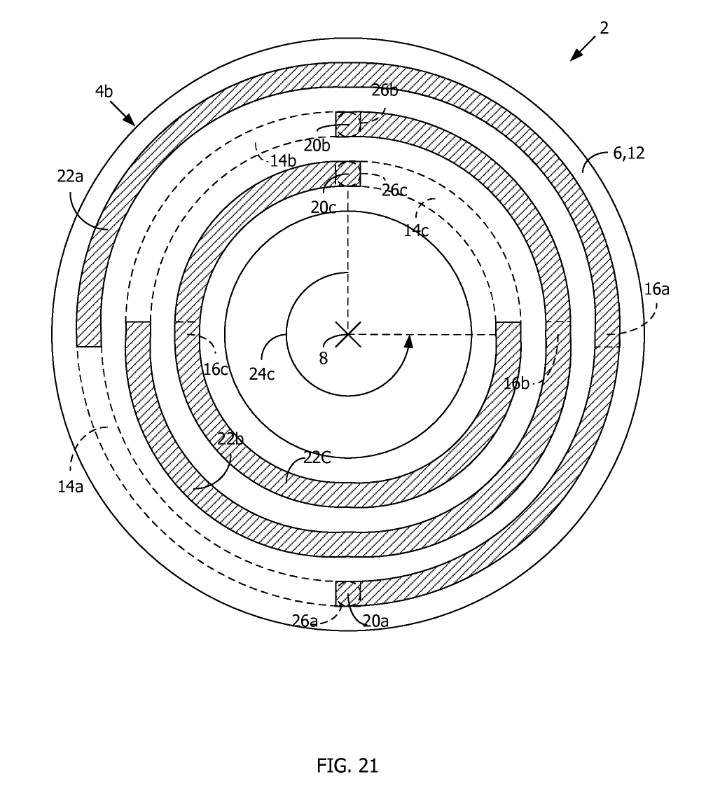

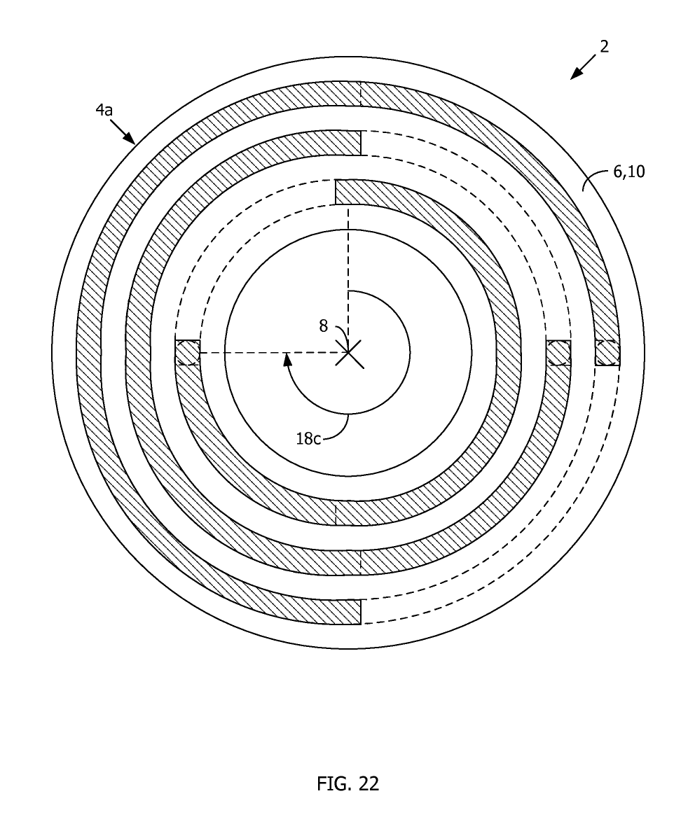

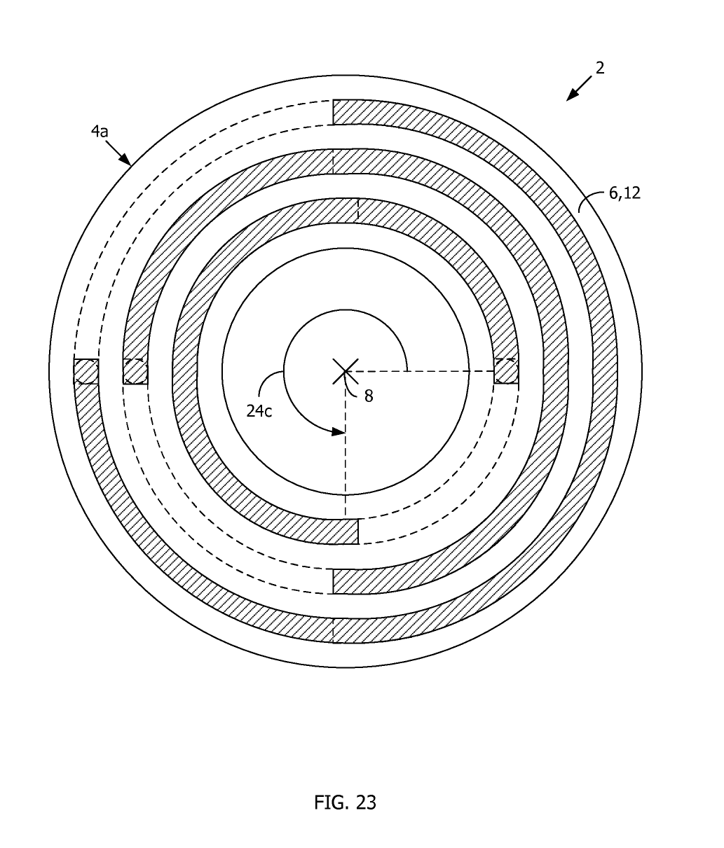

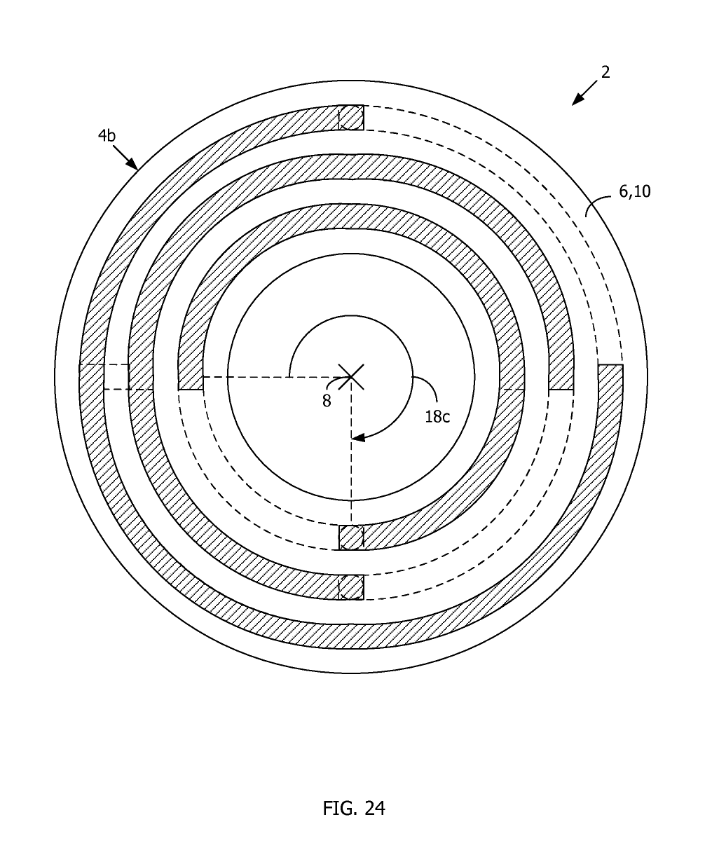

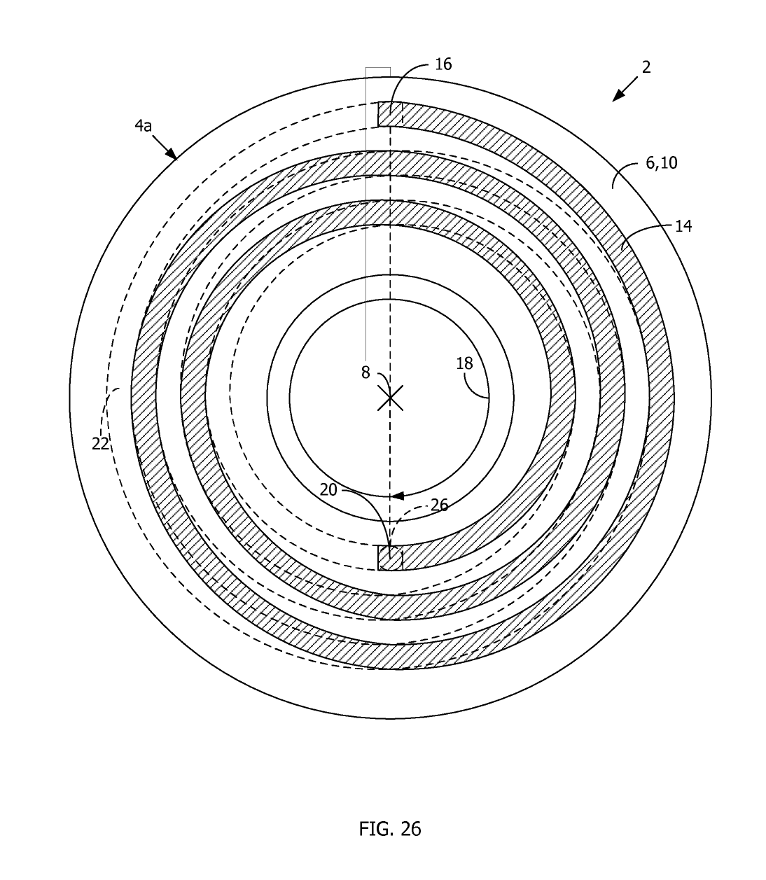

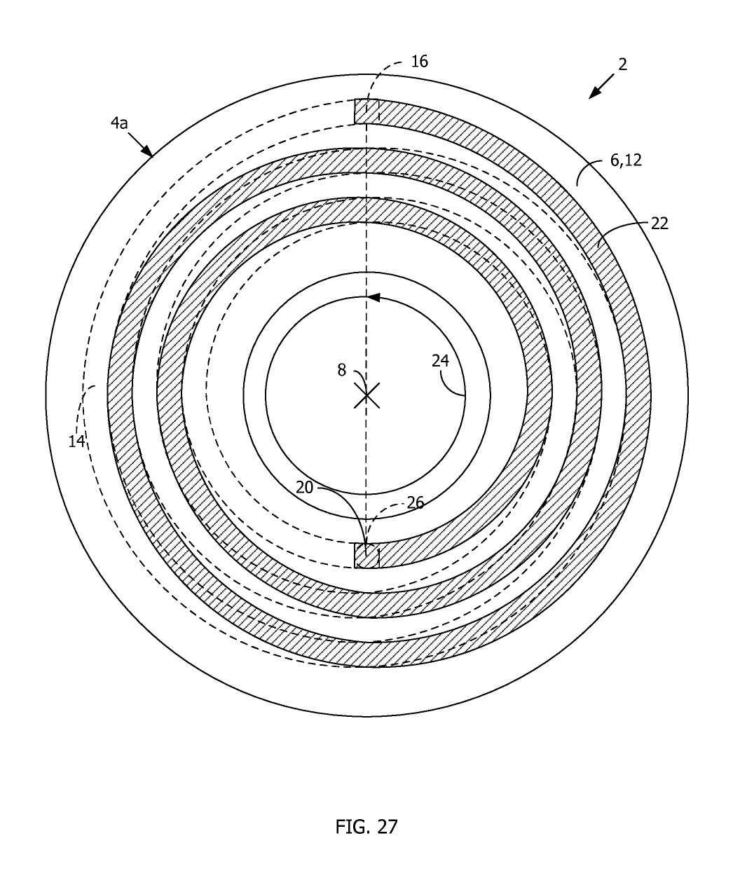

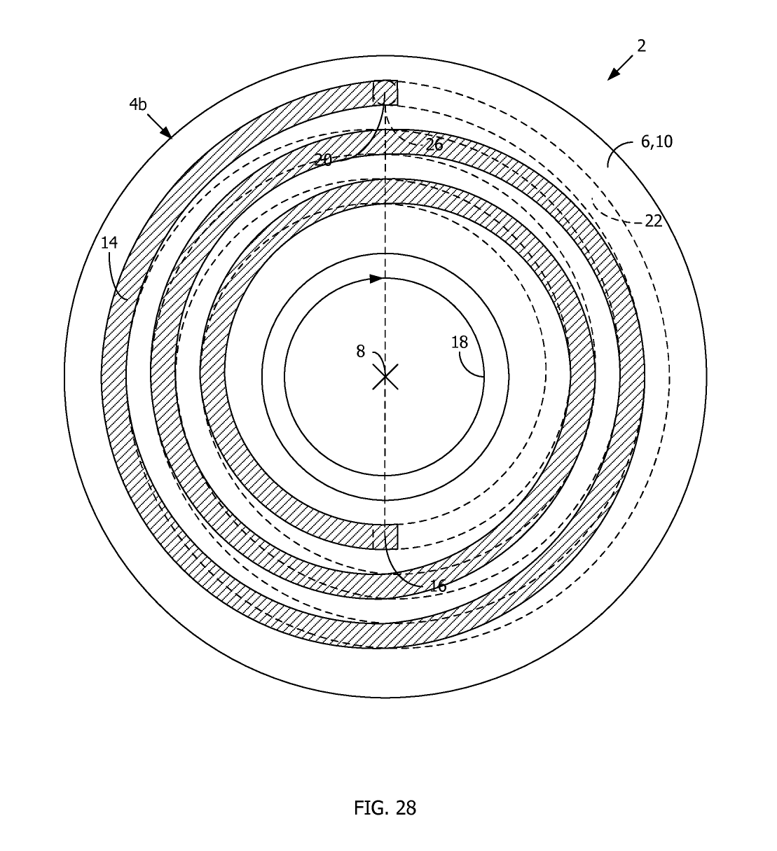

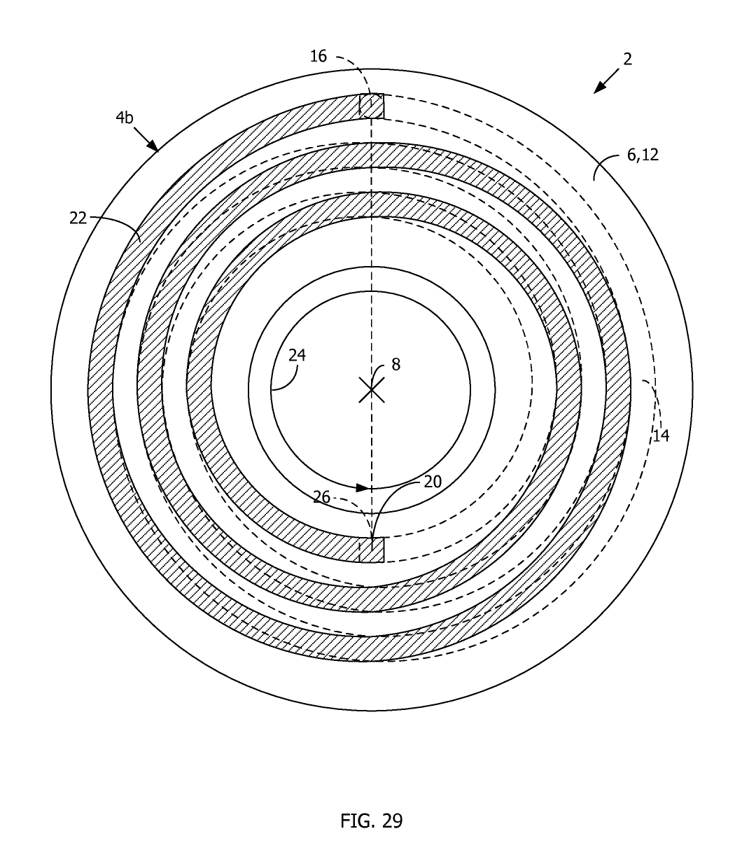

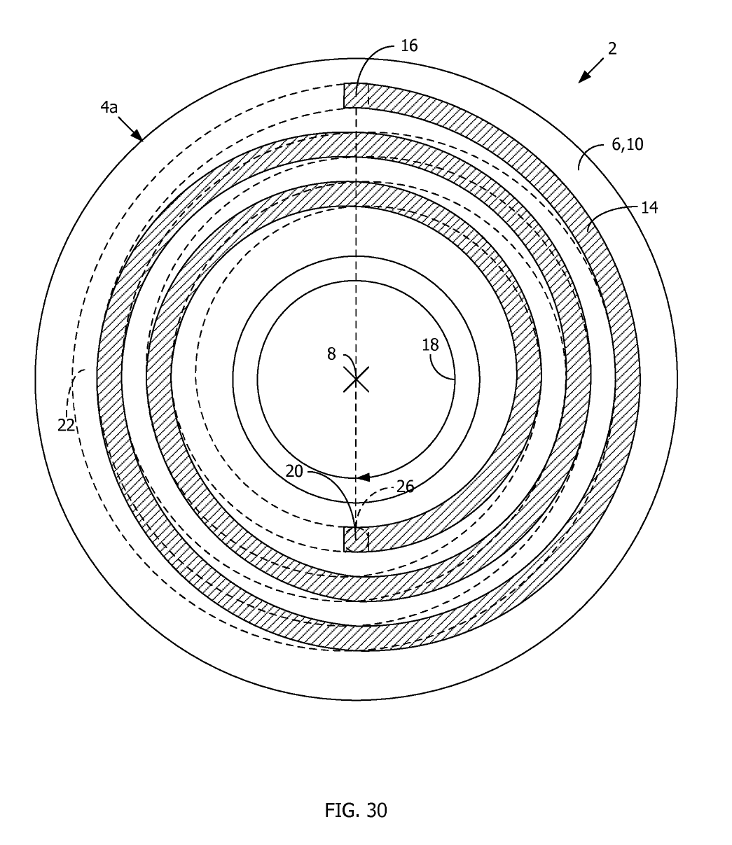

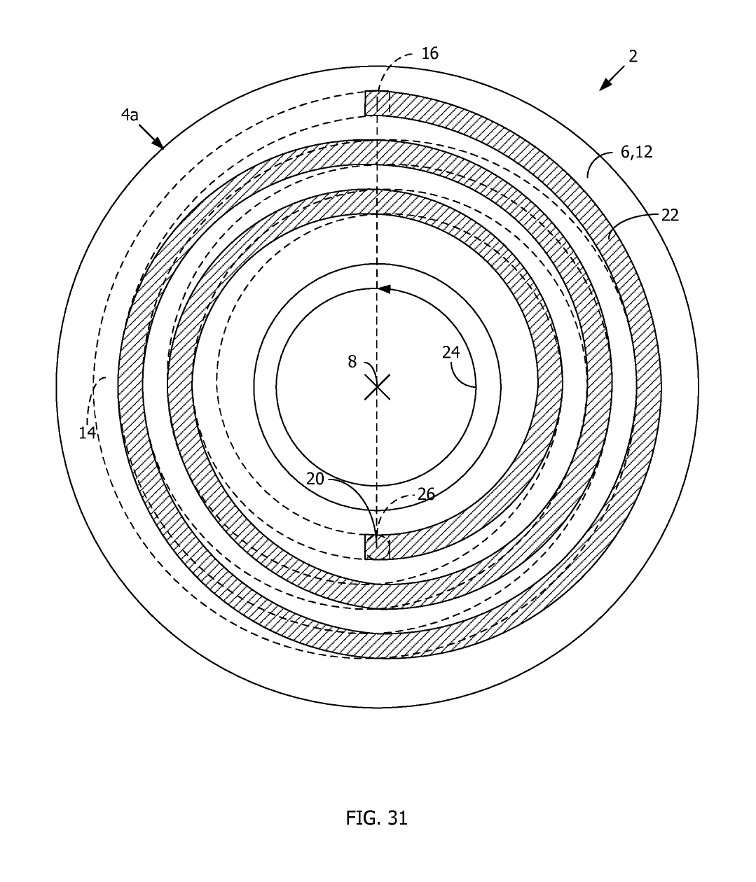

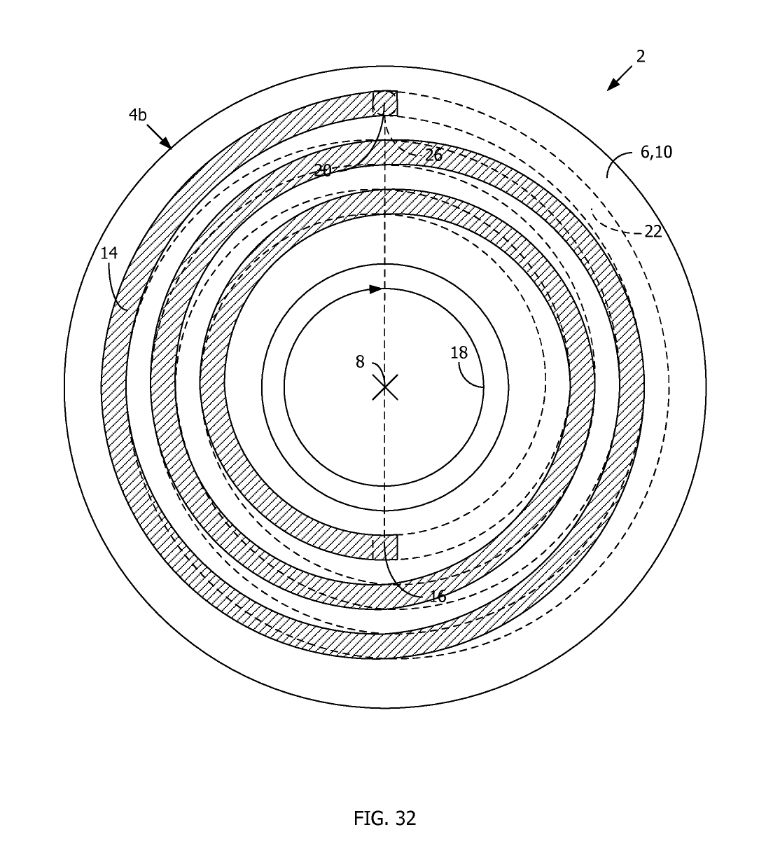

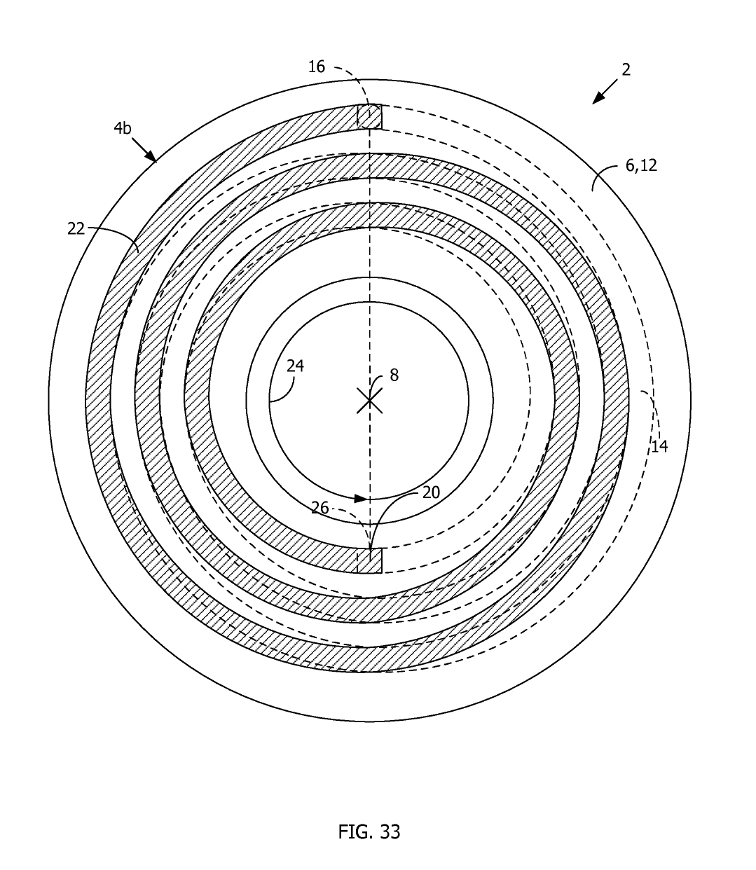

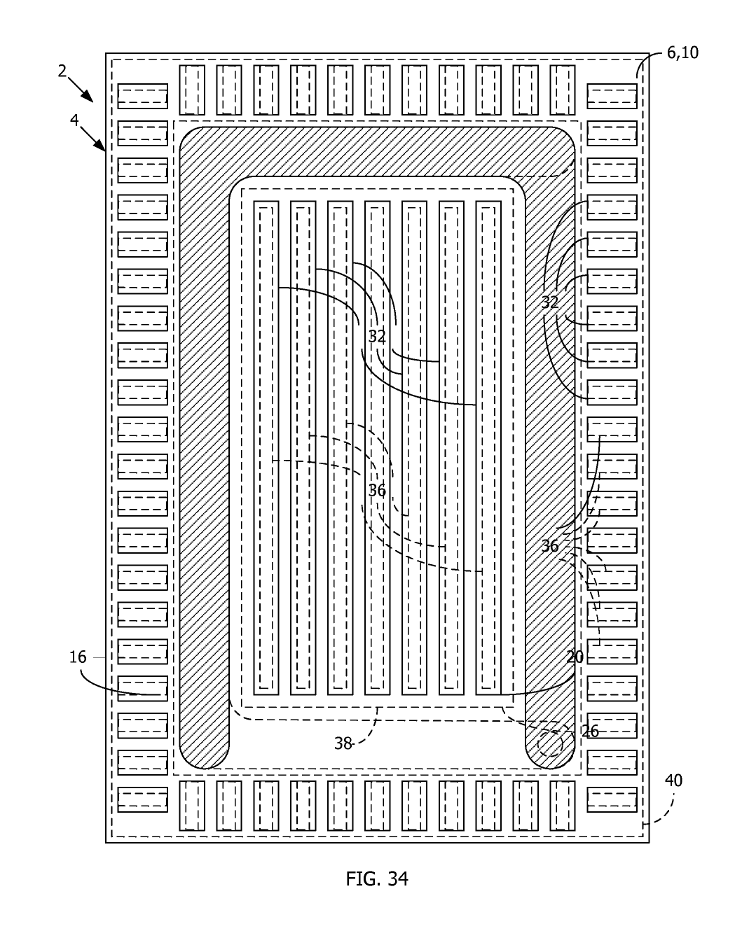

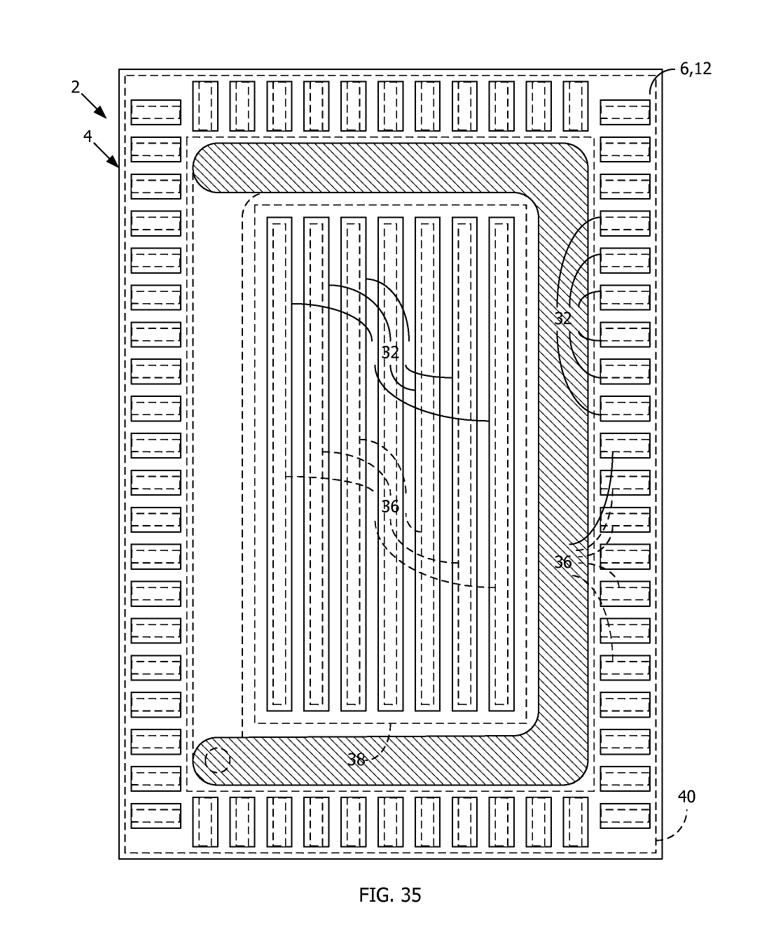

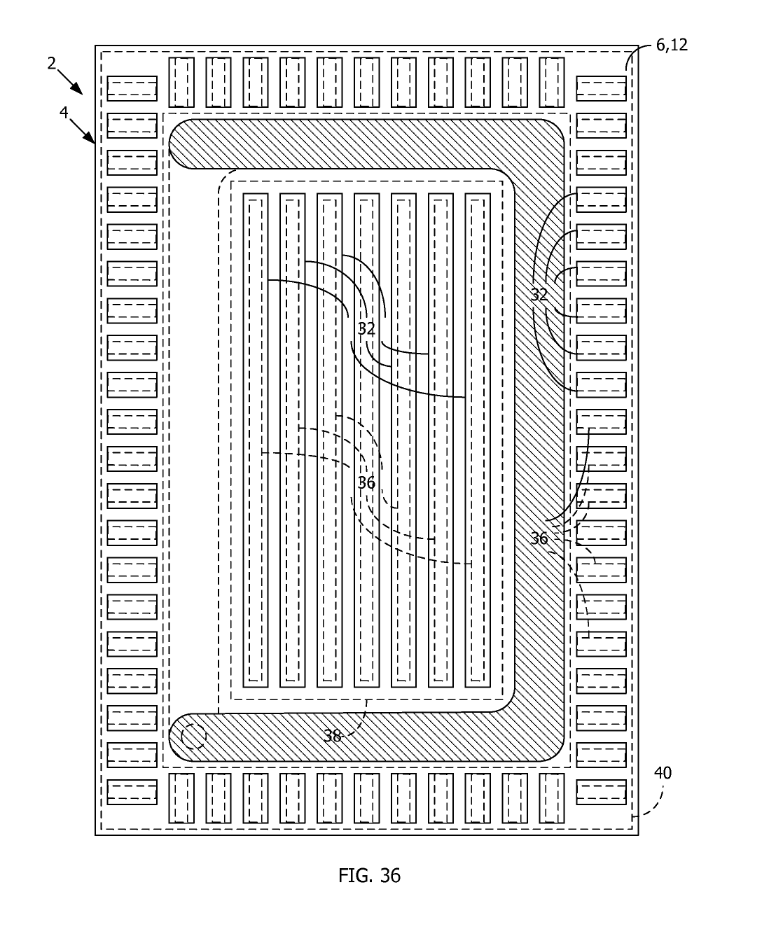

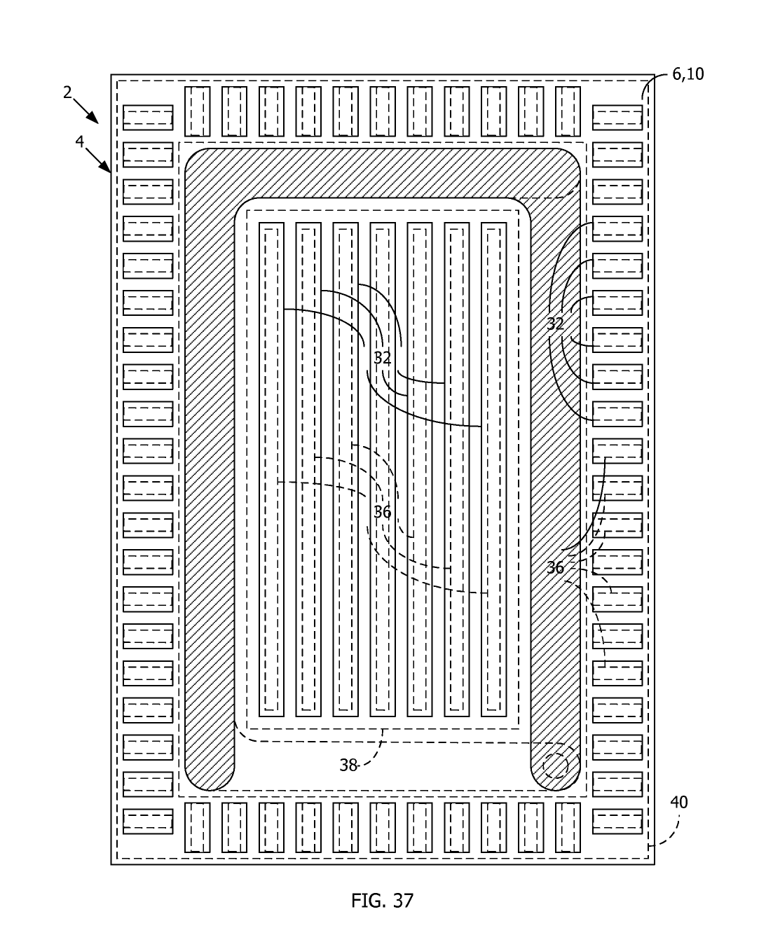

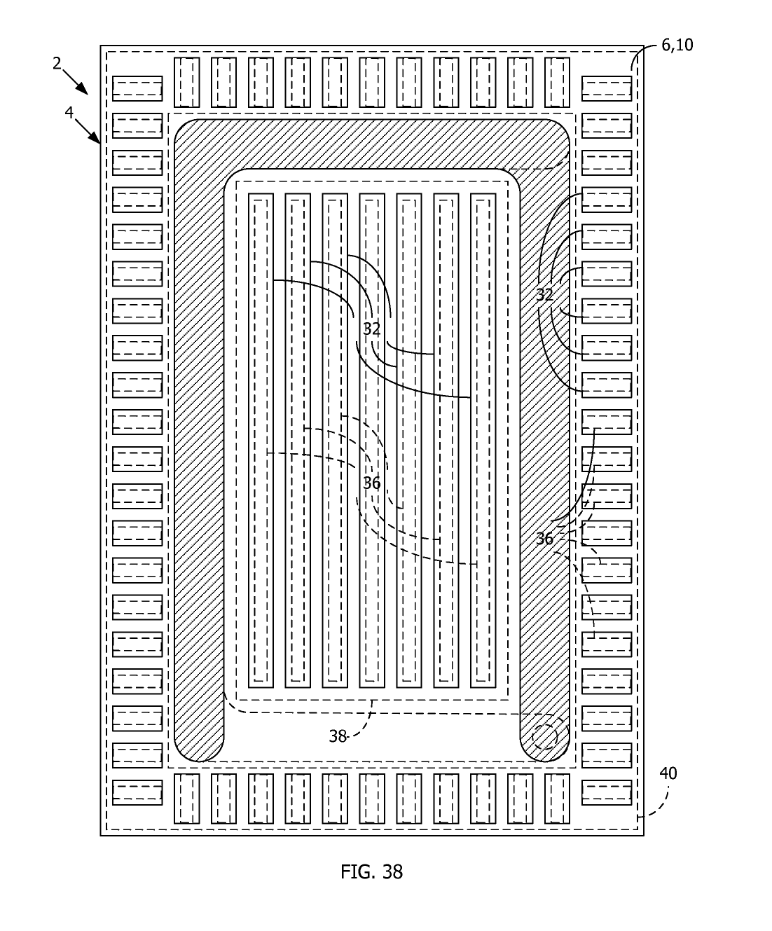

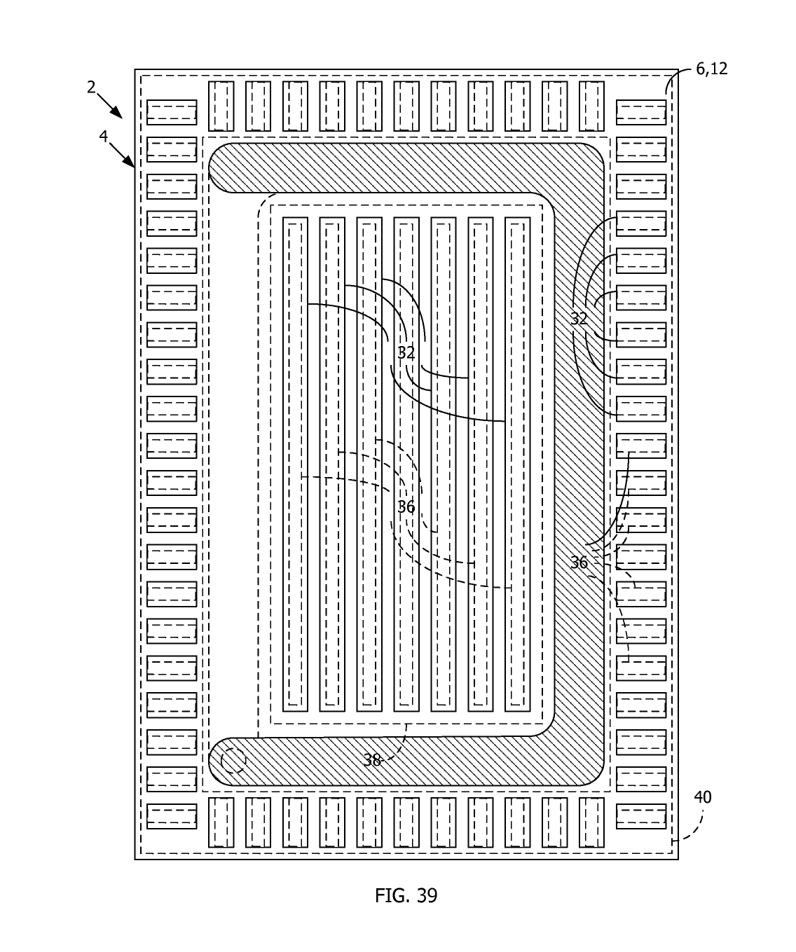

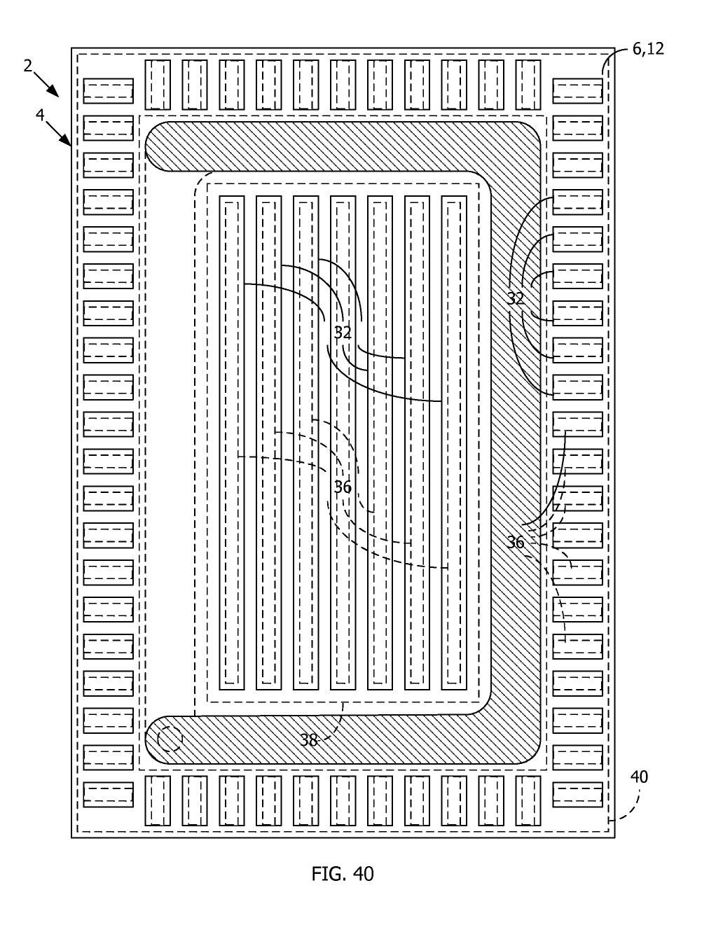

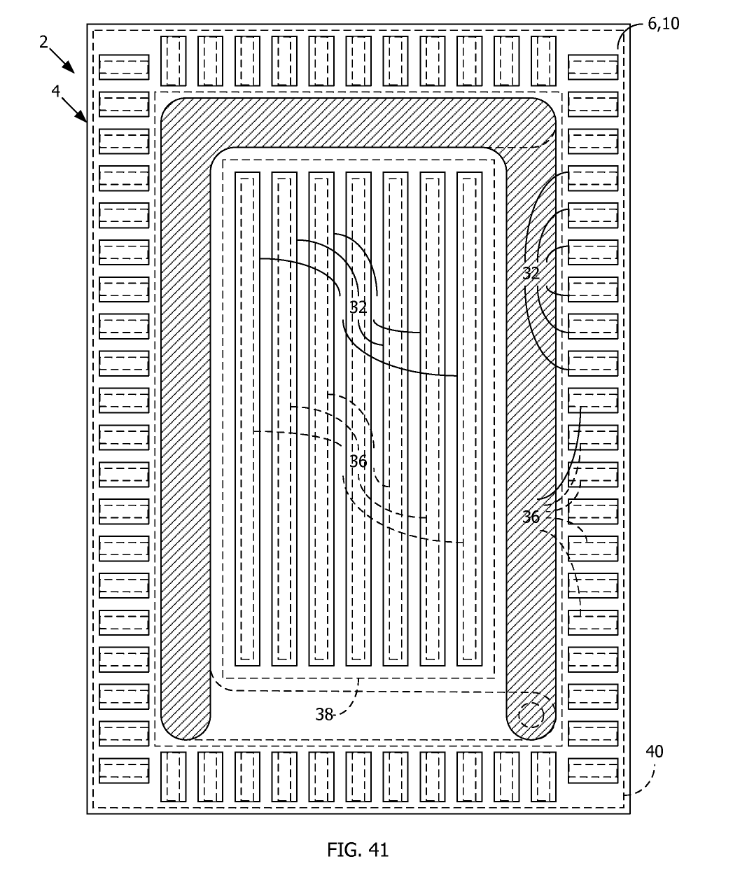

FIGS. 1 through 9 are different views of a first possible embodiment. FIGS. 10 through 17 are views of a second possible embodiment. FIGS. 18 through 25 are views of a third possible embodiment. FIGS. 26 through 33 are views of a fourth possible embodiment. FIGS. 34 through 41 are views of a fifth possible embodiment.

Referring to FIGS. 1 through 9 together, a laminated electrically inductive device 2 according to a first possible embodiment comprises multiple laminations 4. Each lamination 4 comprises a generally planar electrically nonconductive substrate 6 that has a central axis 8 normal to its plane, a first surface 10 and a second surface 12. The substrate 6 may comprise any suitable electrically nonconductive material. For purposes of electrical and mechanical stability during high temperature operation, the substrate 6 may comprise a ceramic sheet.

Referring to FIG. 1 in particular, the first surface 10 of each substrate 6 has at least one electrically conductive pattern 14 in the form of a narrow strip that starts from a first point 16 displaced from the central axis 8 and extends along the first surface 10 about the central axis 8 through a first angle of rotation 18 to a second point 20. The first surface conductive pattern 14 may comprise any convenient plating, cladding or film applied to the substrate 6, such as copper, aluminium or any alloy thereof.

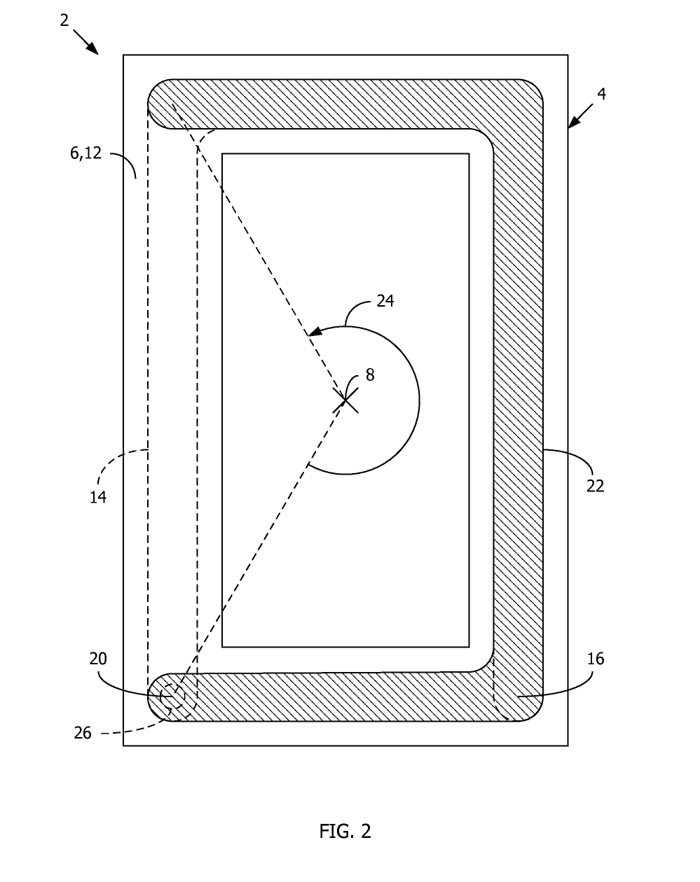

Referring to FIG. 2 in particular, the second surface 12 of each substrate 6 has at least one electrically conductive pattern 22 in the form of a narrow strip that starts from the second point 20 displaced from the central axis 8 and extends along the second surface 12 about the central axis 8 through a second angle of rotation 24 to at least the first point 16. The second surface conductive pattern 22 may comprise any convenient plating, cladding or film applied to the substrate 6, such as copper, aluminium or any alloy thereof.

Referring to FIGS. 1 and 2 together in particular, an electrically conductive coupling region 26 passing through the substrate 6 proximate the second point 20 couples the first surface pattern 14 to the second surface pattern 22. The coupling region 26 may simply be an aperture that allows the first surface pattern 14 to make electrical contact with the second surface pattern 22 at the second point 20, or it may otherwise be a conductive inlay in the substrate 6 or even a connecting member, such as an electrically conductive rivet, that passes through an aperture in the substrate 6.

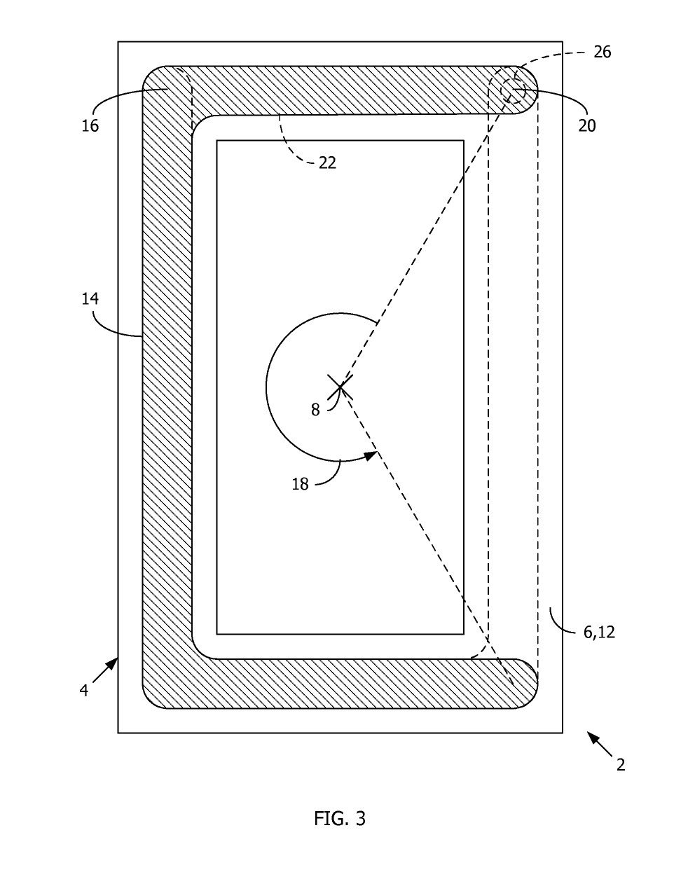

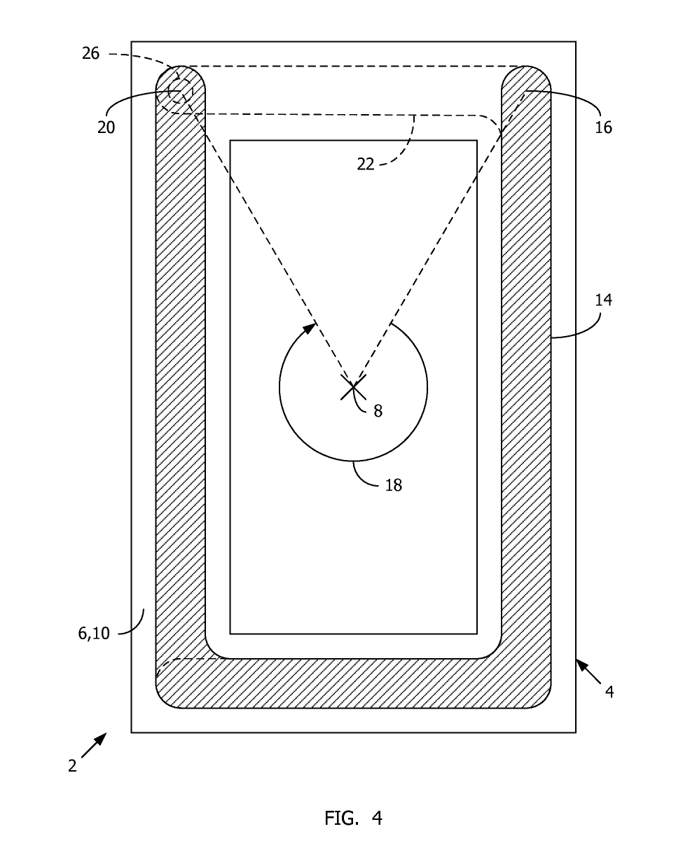

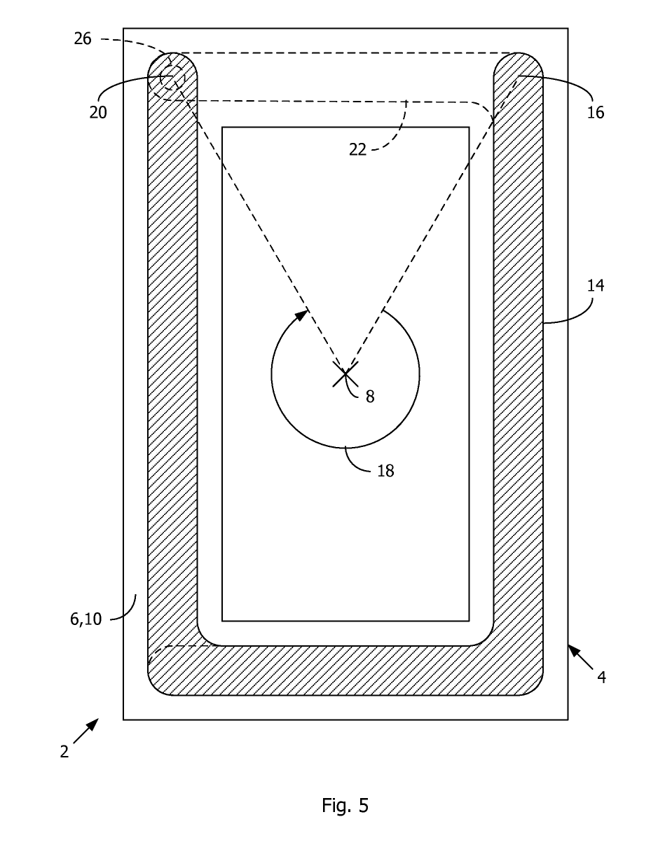

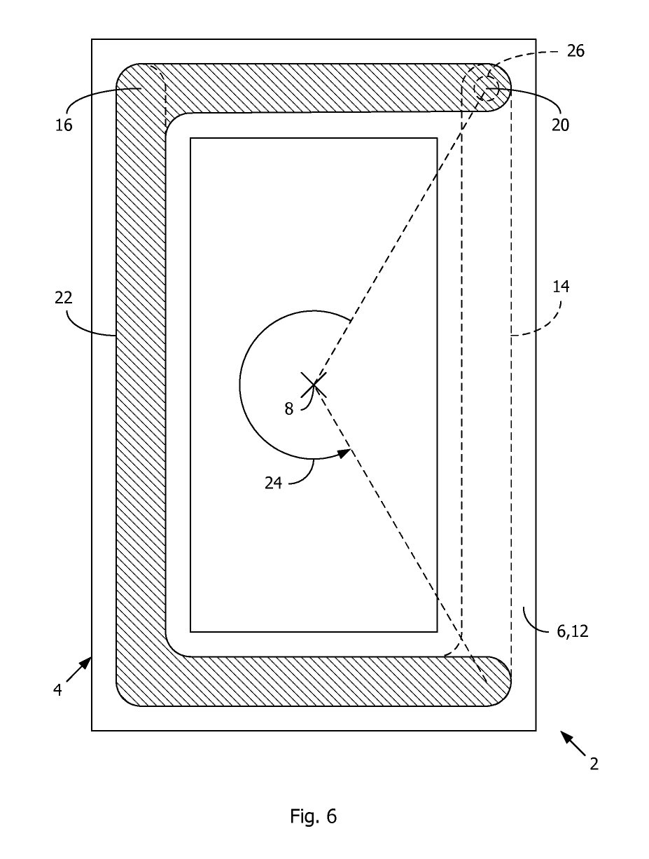

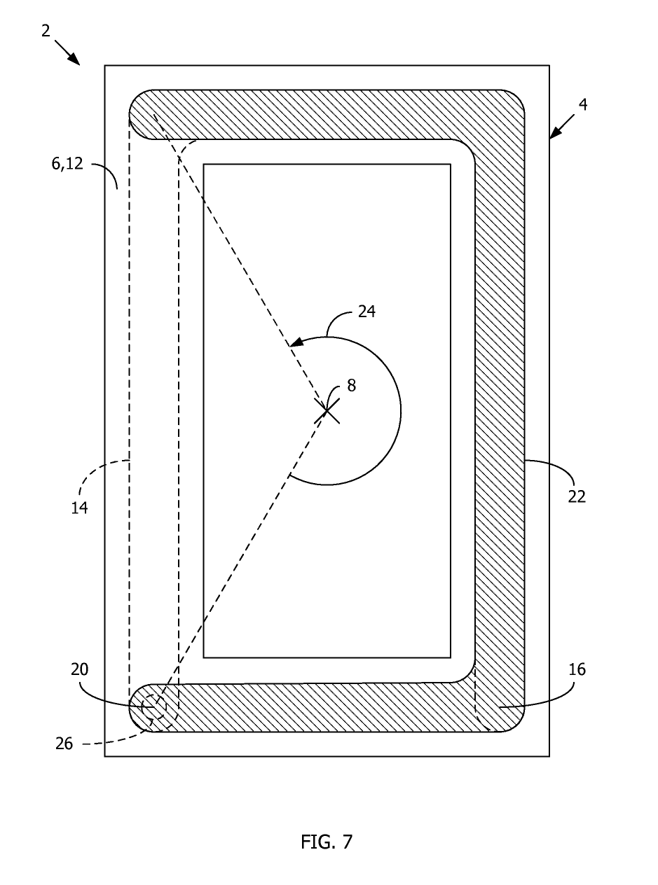

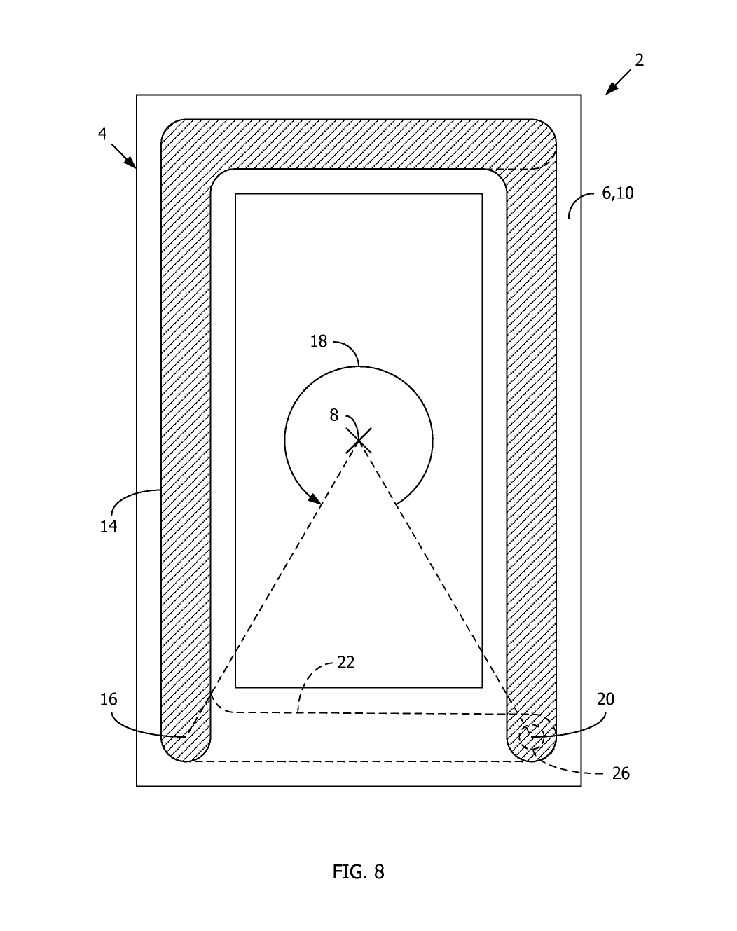

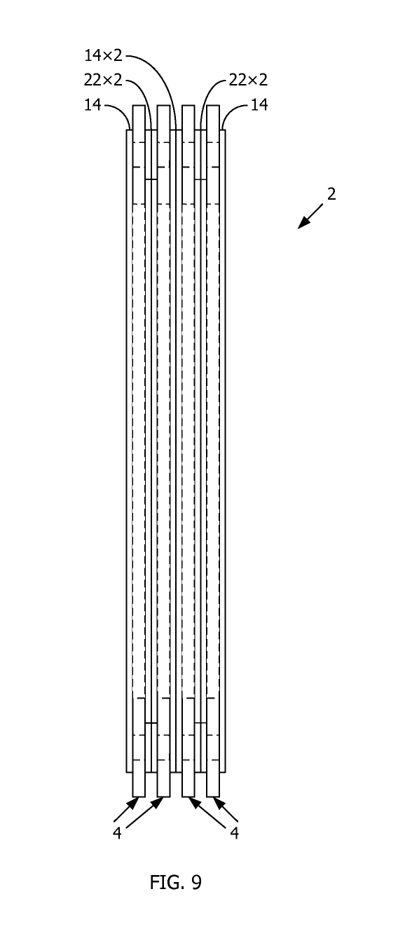

FIG. 9 shows the laminated electrically inductive device 2 with four of the laminations 4 stacked together. The laminated electrically inductive device 2 may comprise any number of the laminations 4. FIG. 1 represents a top view of a first lamination 4 of the laminated electrically inductive device 2. FIG. 2 represents a bottom view of the first lamination 4 of the laminated electrically inductive device 2. FIG. 3 represents a top view of a second lamination 4 of the laminated electrically inductive device 2. FIG. 4 represents a bottom view of the second lamination 4 of the laminated electrically inductive device 2. FIG. 5 represents a top view of a third lamination 4 of the laminated electrically inductive device 2. FIG. 6 represents a bottom view of the third lamination 4 of the laminated electrically inductive device 2. FIG. 7 represents a top view of a fourth lamination 4 of the laminated electrically inductive device 2. FIG. 8 represents a bottom view of the fourth lamination 4 of the laminated electrically inductive device 2.

It is necessary for the adjacent laminations 4 in the laminated electrically inductive device 2 to have matching electrically conductive patterns, represented by the first surface pattern 14 and the second surface pattern 22. In the case, as in the first embodiment, wherein the first surface pattern 14 and the second surface pattern 22 are not symmetrical, it is necessary to match the same types of surface patterns on the adjacent laminations 4. Therefore, the top view of the second lamination 4, as shown in FIG. 3, shows the second surface 12 of the substrate 6 so that its second surface pattern 22 mates with the second surface pattern 22 along the second surface 12 of the first lamination 4 as shown in FIG. 2. Likewise the top view of the fourth lamination 4, as shown in FIG. 7, shows the second surface 12 of the substrate 6 so that its second surface pattern 22 mates with the second surface pattern 22 along the second surface 12 of the first lamination 4 as shown in FIG. 6.

In the first embodiment, the first surface pattern 14 along the first surface 10 and the second surface pattern 22 along the second surface 12 together form a closed planar shape. This shape may be rectangular, as shown, in which case the first surface pattern 14 is not symmetric with the second surface pattern 22, or alternatively may have almost any closed form that comprises rectilinear outer sides, such a triangle, square, hexagon, and so forth, or at least one curvilinear side, such as a circle or pincushion shape. Shapes such as a square, hexagon and circle may have the first surface pattern 14 symmetric with the second surface pattern 22, so that the surfaces of the substrates 6 for the laminations 4 that mate are not important. The surface patterns 14 and surface patterns 22 of adjacent laminations 4 may bond together by compression, diffusion bonding or other means.

The first surface pattern 14 and the second surface pattern 22 for each lamination 4 form a complete turn of a winding for the laminated electrically inductive device 2. For such a single layer winding structure, all the laminations 4 may be of a single type. Since the first embodiment of the laminated electrically inductive device 2 as shown in FIGS. 1 through 9 has four laminations 4, it therefore comprises an electrical inductor that has a single layer winding of four turns. Of course, the inductive device 2 may have a lesser number of laminations 4 or a greater number of laminations 4 to achieve a lesser or greater degree of desired electrical inductance.

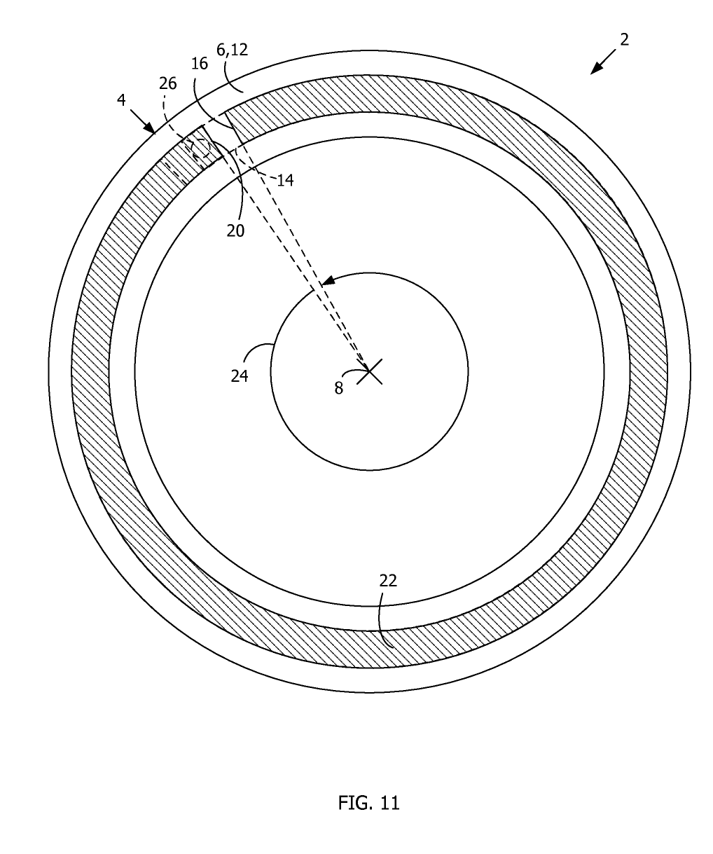

Referring to FIGS. 10 through 17 together, the laminated electrically inductive device 2 according to a second possible embodiment again comprises multiple laminations 4. In this embodiment, for each lamination 4 the first surface pattern 14 along the first surface 10 of the substrate 6 and the second surface pattern 22 along the second surface 12 of the substrate 6 are both generally circular, and together they form a closed circular pattern so that they form a complete turn of a winding for the laminated electrically inductive device 2. Although FIG. 10 shows the first surface pattern 14 extending through the first angle of rotation 18 approaching 360 degrees and FIG. 11 shows the second surface pattern 22 extending through the second angle of rotation approaching 360 degrees, both the first angle of rotation 18 and the second angle of rotation 24 may be smaller, and in fact may be as little as approximately 180 degrees each.

Since the second embodiment of the laminated electrically inductive device 2 has laminations 4 with first surface patterns 14 and second surface patterns 22 that are identical, there is no need to match the same types of surface patterns on the adjacent laminations 4. Thus, in FIGS. 10 through 17, it is evident that in fact adjacent laminations 4 couple first surface patterns 14 with second surface patterns 22. It is only necessary to rotate adjacent laminations 4 relative to each other so that their respective surface patterns line up. Just as with the first embodiment of the laminated electrically inductive device 2, the first surface pattern 14 and the second surface pattern 22 for each lamination 4 form a complete turn of a winding for the laminated electrically inductive device 2. Since the second embodiment of the laminated electrically inductive device 2 as shown in FIGS. 10 through 17 has four laminations 4, it therefore comprises an electrical inductor that has a single layer winding of four turns. Of course, just as with the first embodiment, the inductive device 2 may have a lesser number of laminations 4 or a greater number of laminations 4 to achieve a lesser or greater degree of desired electrical inductance.

Referring to FIGS. 18 through 25 together, the laminated electrically inductive device 2 according to a third possible embodiment again comprises multiple laminations 4. In this embodiment, each lamination 4 comprises multiple concentric first surface layer patterns 14a, 14b and 14c along the first surface 10, multiple concentric second layer patterns 22a, 22b and 22c along the second surface 12 and multiple coupling regions 26a, 26b and 26c there between. This embodiment allows for the laminated electrically inductive device 2 to become a multilayered inductive device with multiple turns in the form of an electrical inductor or transformer, depending on how the first surface patterns 14a, 14b and 14c and the second surface patterns 22a, 22b and 22c interconnect. In FIGS. 18 through 25, the first angle of rotation 18 and the second angle of rotation 24 for all the first surface layer patterns 14 and the second surface layer patterns 22 is approximately 270 degrees.

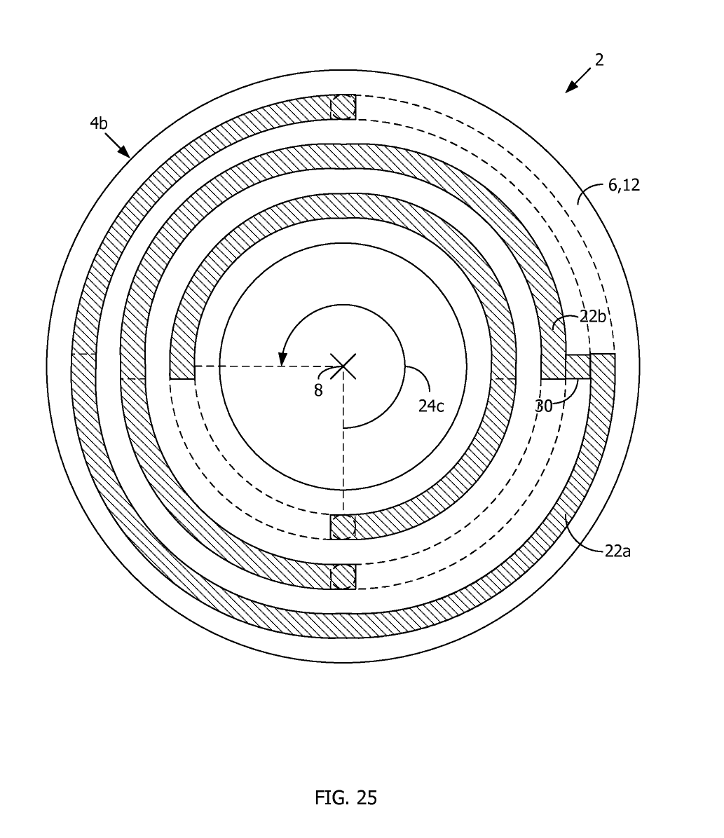

For this embodiment two types of laminations 4 are present, represented by laminations 4a and 4b. They have complementary arrangements of their first surface patterns 14a, 14b and 14c and second surface patterns 22a, 22b and 22c so that when arranged in a stack of laminations represented by 4a, 4b, 4a, 4b, and so forth, as shown in FIGS. 18 through 25, the windings that they represent may allow electrical current flow in a single direction when a first intra-pattern link 28 couples the first surface pattern 14b with the first surface pattern 14c of an outermost lamination 4a, as shown in FIG. 18, and a second intra-pattern link 30 couples the second surface pattern 22a with the second surface pattern 22b of an outermost lamination 4b, as shown in FIG. 25.

The intra-pattern links 28 and 30 may comprise any convenient plating, cladding or film applied to the substrate 6, such as copper, aluminium or any alloy thereof. Inclusion of both the intra-pattern links 28 and 30 will result in the laminated electrically inductive device 2 having the form of an electrical inductor with a three-layer winding of four turns each. Removal of either the first intra-pattern link 28 or the second inter-pattern link will result in the laminated electrically inductive device 2 having the form of an electrical transformer that comprises a single layer primary with four turns and a two layer secondary with a total of eight turns.

Referring to FIGS. 26 through 33 together, the laminated electrically inductive device 2 according to a fourth possible embodiment again comprises multiple laminations 4. In this embodiment, each lamination 4 comprises a first surface layer pattern 14 along the first surface 10 that extends through the first angle of rotation 18 and the second surface layer pattern 22 extends through the first angle of rotation 24, with both the first angle of rotation 18 and the second angle of rotation 24 exceeding 360 degrees to let the first surface layer pattern 14 and the second surface layer pattern 22 assume generally spiral figures. In FIGS. 26 through 33 the first angle of rotation 18 and the second angle of rotation 24 are approximately 360 plus 270, or 630 degrees.

For this embodiment two types of laminations 4 are present, represented by laminations 4a and 4b. They have complementary arrangements of their first surface patterns 14 and second surface patterns 22 so that when arranged in a stack of laminations represented by 4a, 4b, 4a, 4b, and so forth, as shown in FIGS. 26 through 33, the windings that they represent may allow electrical current flow in a single direction. With this arrangement, the fourth embodiment as shown in FIGS. 26 through 33 will result in the laminated electrically inductive device 2 having the form of an electrical inductor with a three-layer winding of four turns each. Of course, the laminated electrically inductive device 2 may have additional laminations 4 and the first angle of rotation 18 and the second angle of rotation 24 may be greater than 630 degrees to achieve an electrical inductance with a greater number of windings and layers. Furthermore, the laminated electrically inductive device 2 may have laminations 4 that comprise multiple concentric first surface layers 14 and second layers 22, all assuming the spiral form, to achieve additional electrical inductance or transformer operation.

Referring to FIGS. 34 through 41 together, the laminated electrically inductive device 2 according to a fifth possible embodiment again comprises multiple laminations 4. This embodiment is electrically identical to the first embodiment as described in connection with FIGS. 1 through 9, but it includes additional magnetic circuit elements. Specifically, each lamination 4 includes at least one first magnetically permeable layer pattern 32 along the first surface 10 of the substrate 6, at least one magnetically permeable layer pattern 34 along the second surface 12 of the substrate 6 and at least one magnetically permeable coupling region 36 passing through the substrate 6 that magnetically couples the first magnetically permeable layer pattern 34 to the second magnetically permeable layer 36.

The first surface magnetically permeable pattern 32 and the second surface magnetically permeable pattern may 34 comprise any convenient magnetically permeable plating, cladding or film applied to the substrate 6, such as a ferrous or ferrite material. The magnetically permeable coupling region 36 may simply be an aperture that allows the first magnetically permeable surface pattern 32 to contact the second magnetically permeable surface pattern 34, or it may otherwise be a magnetically permeable inlay in the substrate 6 or even a magnetically permeable connecting member that passes through an aperture in the substrate 6.

As shown in FIGS. 34 through 41, the first magnetically permeable surface patterns 32, the second magnetically permeable surface patterns 34 and the magnetically permeable coupling regions 36 may assume the shape of narrow strips to form magnetically permeable laminations to reduce eddy current effects. Furthermore, as also shown, the first magnetically permeable surface patterns 32, the second magnetically permeable surface patterns 34 and the magnetically permeable coupling regions 36 may form a magnetically permeable core region 38 within the winding of the laminated electrically inductive device 2 or a magnetically permeable shield region 40 outside of the winding of the laminated electrically inductive device 2. Furthermore, magnetically permeable shunts (not shown) may connect the magnetically permeable core region 38 with the magnetically permeable shield region 40 along the exterior surfaces of the laminated electrically inductive device 2 to let it become a highly inductive, magnetically shielded inductor with a closed magnetic circuit.

The described embodiments as set forth herein represent only illustrative implementations of the invention as set forth in the attached claims. Changes and substitutions of various details and arrangement thereof are within the scope of the claimed invention.

1. A electrically inductive device that comprises multiple laminations, each lamination comprising:
a generally planar electrically nonconductive substrate that has a central axis normal to its plane, a first surface and a second surface;
at least one electrically conductive layer pattern along the first surface in the form of a narrow strip that starts from a first point displaced from the central axis and extends along the first surface about the central axis through a first angle of rotation to a second point;
at least one electrically conductive layer pattern along the second surface in the form of a narrow strip that starts from the second point and extends along the second surface about the central axis through a second angle of rotation to at least the first point; and
an electrically conductive coupling region passing through the substrate proximate the second point that couples the electrically conductive layer pattern along the first surface to the electrically conductive layer pattern along the second surface;
wherein stacking the laminations upon each other form at least one winding with multiple turns for the inductive device.

2. The inductive device of claim 1, wherein the inductive device comprises an inductor.

3. The inductive device of claim 1, wherein the inductive device comprises a transformer.

4. The inductive device of claim 1, wherein the electrically conductive layer pattern along the first surface and the electrically conductive layer pattern along the second surface form a closed planar figure.

5. The inductive device of claim 4, wherein the closed planar figure has multiple rectilinear outer sides.

6. The inductive device of claim 4, wherein the closed planar figure has at least a curvilinear outer side.

7. The inductive device of claim 4, wherein the first angle of rotation and the second angle of rotation are each within a range of approximately 180 and nearly 360 degrees.

8. The inductive device of claim 4, wherein the laminations are of a single type.

9. The inductive device of claim 8, wherein the electrically conductive layer pattern along the first surface is symmetric with the electrically conductive layer pattern along the second surface.

10. The inductive device of claim 8, wherein the electrically conductive layer pattern along the first surface is non-symmetric with the electrically conductive layer pattern along the second surface.

11. The inductive device of claim 10, wherein adjacent laminations have the electrically conductive layer pattern of their first surfaces mating and the electrically conductive layer pattern of their second surfaces mating.

12. The inductive device of claim 1, wherein the first angle of rotation of the electrically conductive layer pattern along the first surface and second angle of rotation of the electrically conductive layer pattern along the second surface both exceed 360 degrees to assume generally spiral figures that form a multilayered inductive device with multiple turns per layer.

13. The inductive device of claim 12, wherein adjacent laminations have mating complimentary spiral layer patterns on their surfaces.

14. The inductive device of claim 1, wherein each lamination comprises multiple concentric layer patterns along the first surface, multiple concentric layer patterns along the second surface and multiple coupling regions there between to form a multilayered inductive device with multiple turns.

15. The inductive device of claim 14, wherein adjacent laminations have mating complimentary concentric layer patterns on their surfaces.

16. The inductive device of claim 1, further comprising:
at least one magnetically permeable layer pattern along the first surface;
a least one magnetically permeable layer pattern along the second surface that is in general alignment with the magnetically permeable layer pattern along the first surface;
at least one magnetically permeable coupling region passing through the substrate that couples the magnetically permeable layer pattern along the first surface to the magnetically permeable layer pattern along the second surface.

17. The inductive device of claim 16, wherein the laminated magnetically permeable patterns form a magnetic core for the inductive device.

18. The inductive device of claim 16, wherein the laminated magnetically permeable patterns form a magnetic shell for the inductive device.

19. An electrical inductor that comprises multiple laminations, each lamination comprising:
a generally planar electrically nonconductive substrate that has a central axis normal to its plane, a first surface and a second surface;
at least one electrically conductive layer pattern along the first surface in the form of a narrow strip that starts from a first point displaced from the central axis and extends along the first surface about the central axis through a first angle of rotation to a second point;
at least one electrically conductive layer pattern along the second surface in the form of a narrow strip that starts from the second point and extends along the second surface about the central axis through a second angle of rotation to at least the first point; and
an electrically conductive coupling region passing through the substrate proximate the second point that couples the electrically conductive layer pattern along the first surface to the electrically conductive layer pattern along the second surface;
wherein stacking the laminations upon each other form a winding with multiple turns for the inductor.

20. The inductor of claim 19, wherein the first angle of rotation of the electrically conductive layer pattern along the first surface and second angle of rotation of the electrically conductive layer pattern along the second surface both exceed 360 degrees to assume generally spiral figures that form a multilayered inductor with multiple turns per layer.

21. The inductor of claim 20, wherein adjacent laminations have mating complimentary spiral layer patterns on their surfaces.

22. The inductor of claim 19, wherein each lamination comprises multiple concentric layer patterns along the first surface, multiple concentric layer patterns along the second surface and multiple coupling regions there between to form a winding with multiple turns per layer for the inductor.

23. The inductor of claim 22, wherein adjacent laminations have mating complimentary concentric layer patterns on their surfaces.

24. An electrical transformer that comprises multiple laminations, each lamination comprising:
a generally planar electrically nonconductive substrate that has a central axis normal to its plane, a first surface and a second surface;
at least one electrically conductive layer pattern along the first surface in the form of a narrow strip that starts from a first point displaced from the central axis and extends along the first surface about the central axis through a first angle of rotation to a second point;
at least one electrically conductive layer pattern along the second surface in the form of a narrow strip that starts from the second point and extends along the second surface about the central axis through a second angle of rotation to at least the first point; and
an electrically conductive coupling region passing through the substrate proximate the second point that couples the electrically conductive layer pattern along the first surface to the electrically conductive layer pattern along the second surface;
wherein stacking the laminations upon each other form at least two windings with multiple turns for the transformer.

25. The transformer of claim 24, wherein adjacent laminations have mating complimentary spiral layer patterns on their surfaces.

26. The transformer of claim 24, wherein each lamination comprises multiple concentric layer patterns along the first surface, multiple concentric layer patterns along the second surface and multiple coupling regions there between to form a winding with multiple turns per layer for the inductor.

27. The transformer of claim 26, wherein adjacent laminations have mating complimentary concentric layer patterns on their surfaces.
